(19) United States
(12) Patent Application Publication
(10) Pub. No.: US 2003/0230243 A1
(43) Pub. Date: Dec. 18, 2003

(54) A DEVICE FOR AUTOMATICALLY MILKING ANIMALS

(75) Inventors: Alexander Van Der Lely, Rotterdam (NL); Marcel Van Leeuwen, Maasdijk (NL)

Correspondence Address: HOWREY SIMON ARNOLD & WHITE, CITYPOINT, ONE ROPEMAKER STREET, LONDON, EC2Y 9HS, GB

(73) Assignee: LELY ENTERPRISES AG, Zug (CH)

(21) Appl. No.: 10/249,970

(22) Filed: May 23, 2003

(30) Foreign Application Priority Data
Jun. 6, 2002 (NL) 1020787

(51) Int. Cl. A01J 3/00

(52) U.S. Cl. 119/14.08; 119/14.25

(57) ABSTRACT

A device for automatically milking dairy animals. The device has a teat cup for drawing milk from a dairy animal and for generating a milk-air mixture, a robot arm for automatically connecting the teat cup to a teat of the dairy animal, a single milk-collecting vessel provided with a vacuum connection connected to a vacuum source, a milk outlet for discharging the milk to milk-processing means, such as a milk-cooling tank and at least one milk inlet for letting the milk-air mixture in, at least one milk connection device between a teat cup and the milk inlet for conveying the milk-air mixture, and a vessel-cooling device for cooling the contents of a milk-collecting vessel, which vessel-cooling device comprises a cooling surface having a milk side for contact with the milk and having a cooling medium side for contact with a cooling medium.

### CROSS REFERENCE TO RELATED APPLICATIONS

This application claims priority from Dutch patent application no. 1020787 filed Jun. 6, 2002, the contents of which are hereby incorporated by reference in their entirety.

### BACKGROUND OF INVENTION

1. Field of the Invention

The invention relates to the field of milking and more particularly to devices for automatically milking dairy animals.

2. Description of the Related Art

Devices are known for automatically milking dairy animals. Such devices may comprise a teat cup for drawing milk from the dairy animal and for generating a milk-air mixture and a milk-collecting vessel provided with a vacuum connection connectable to a vacuum source. The milk-collecting vessel may be provided with a vessel-cooling device for cooling the contents of the milk-collecting vessel.

It is also known to use a milking robot by which the teat cups can automatically be connected to the teats of the cow. The teat cups are connected to a first milk-collecting vessel. Said milk-collecting vessel has a vacuum connection to a vacuum pump for the purpose of bringing the milk-collecting vessel under vacuum. The vacuum ensures the conveyance to the milk-collecting vessel of a milk-air mixture that is generated in the teat cups. Via a connection in the lower part of the milk-collecting vessel, said milk-collecting vessel is connected to a second milk-collecting vessel. From the second milk-collecting vessel the milk can be conveyed to a milk-cooling tank for cooled storage. The milk is stored temporarily in the second milk-collecting vessel if the milk-cooling tank is not available. Between the first and the second milk-collecting vessel there is further provided a vacuum connection for enabling milk to flow from the first to the second milk-collecting vessel. The second milk-collecting vessel may be designed as a pre-cooling device, so that milk has already been cooled prior to being passed into the milk-cooling tank.

European patent application EP 0797915-A2, the contents of which are hereby incorporated by reference in their entirety, describes a device for automatically milking animals of the above type.

Although such devices function properly, many lines and accessories are required for performing milk-air separation and for pre-cooling the milk. As a result thereof, such devices are relatively expensive and require considerable maintenance.

### SUMMARY OF INVENTION

According to one aspect of the present invention it would be desirable to provide a simple device having the advantages of pre-cooling milk.

According to the invention, for this purpose a device is provided for automatically milking dairy animals, comprising a teat cup for drawing milk from a dairy animal and for generating a milk-air mixture, a robot arm for automatically connecting the teat cup to a teat of the dairy animal, a single milk-collecting vessel provided with a vacuum connection connectable to a vacuum source, with a milk outlet for discharging the milk to milk-processing means, such as a milk-cooling tank, and with at least one milk inlet for letting the milk-air mixture in, at least one milk connection device between a teat cup and the milk inlet for conveying the milk-air mixture and a vessel-cooling device for cooling the contents of the milk-collecting vessel, which vessel-cooling device comprises a cooling surface having a milk side for contact with the milk and having a cooling medium side for contact with the cooling medium. The cooling surface of the milk-collecting vessel has the function of pre-cooling the milk. Via the vacuum connection of the milk-collecting vessel, the air is removed from the milk-air mixture coming from the teat cups. Due to the particular fact that the functions of pre-cooling and air-separation are integrated in one element, there is created a compact and simple device.

According to an advantageous embodiment of the invention, the cooling medium side constitutes part of the wall of a cooling medium space for containing the cooling medium. As a result thereof, in the region where the heat transfer to the cooling medium takes place, i.e. at the cooling medium side, a large amount of cold cooling medium is available. This ensures a buffering action for the heat transfer.

In a further embodiment according to the invention, there are disposed moving means for moving the cooling medium in the cooling medium space. In this way there can take place a better heat transfer from the wall of the cooling medium space to the cooling medium.

In another embodiment, the cooling medium space comprises a cooling medium inlet and a cooling medium outlet for the cooling medium. In this way it is possible to dispose a cooling device at some distance, and to pass via lines cold cooling medium to and warm cooling medium from the milk-collecting vessel. As a result thereof the milk-collecting vessel itself can be maintained simple and compact.

In an advantageous embodiment of the invention, the device comprises a drinking trough for watering an animal and the cooling medium outlet is connected via a line to the drinking trough. By using cold drinking-water as cooling medium, the warmed up drinking-water can be supplied on the spot to an animal located in or near the device. In this way the warmed up cooling medium can be re-used in a simple manner.

In a particular embodiment, the device comprises means for using ice water as cooling medium. If ice water is used as cooling medium, freezing of milk in the milk-collecting vessel is impossible. Furthermore, the occurrence of dangerous situations in the case of leakage is excluded, because ice water is harmless to human beings and animals.

In another embodiment, the milk-collecting vessel comprises a vacuum regulator for regulating the vacuum in the milk-collecting vessel. By means of this the milking vacuum can be regulated near the place where the milking process takes place, i.e. the milk-collecting vessel.

In a particular embodiment, the wall of the milk-collecting vessel comprises the cooling surface. In general, the contact surface with the milk has to be as small as possible for enabling a simple cleaning and for minimising the risk of contamination. By means of this embodiment, a largest possible part of the contact surface is used for cooling, so that the total contact surface is maintained small.

In a further embodiment, the milk inlet is disposed at the upper side of the milk-collecting vessel. In this way the milk inlet is always located above the milk surface, so that flowing back of milk into the supply line is impossible.

In a further embodiment, the cooling surface comprises a spreading surface for spreading the milk to be supplied to the milk-collecting vessel. Via said spreading surface the force of the incoming milk squirt is slowed down.

In an advantageous embodiment according to the invention, the milk inlet is located above the spreading surface. In this way the incoming milk will always land on the spreading surface by free fall, irrespective of the speed or the rate of flow of the incoming milk flow.

In another embodiment, the spreading surface makes an angle of between 10 Å° and 80 Å° relative to the vertical. Due to such a spreading surface, the incoming milk flow will flow slowly and steadily downwards in a thin layer via the spreading surface. By means of this a great impact of milk is prevented, which is beneficial to the milk quality.

In a further embodiment, the cooling surface comprises at least partially the spreading surface. The milk flowing in a thin and relatively large layer over the spreading surface provides a good heat transfer from the milk to the cooler spreading surface.

In a particular embodiment, the wall of the milk-collecting vessel surrounds at least partially the cooling surface. This enables a simple production of the milk-collecting vessel, because the cooling surface may constitute part of a separate cooling element that can be disposed in the milk-collecting vessel in a late stage of the production process.

In a further embodiment, the cooling surface comprises the surface of a coil cooler. A coil cooler is relatively simple and can relatively easily be cleaned because of its tubular contact surface.

In a variant of the invention, the cooling surface comprises a plate cooler. This enables a large heat transfer over a relatively small volume.

An advantageous embodiment of the device is characterized in that the device comprises a connection-device-cooling device for cooling milk to be passed through the milk connection device. In this way the milk can be cooled already immediately after having left the teat cups, which limits bacterial growth in the milk and on the lines. By using cooling medium from the milk-collecting vessel for this cooling, a minimum amount of lines will suffice.

In a further embodiment, the connection-device-cooling device is disposed on the robot arm. In this way no extra movable carrier construction for said cooling device is required.

In yet another embodiment, there is provided a line for connecting the vessel-cooling device to the connection-device-cooling device. In this way both cooling devices can be cooled with the same cooling medium.

By connecting the connection-device-cooling device to the cooling medium outlet, the warmest cooling medium is used for the first cooling. This is the most favourable procedure to obtain an optimum cooling capacity of the entire device.

By surrounding the milk-collecting vessel by a thermally insulating insulation layer, warming up of the cooling medium by the environment is limited. Besides, the insulation layer also offers advantages upon internally cleaning the device with a warm cleaning agent.

In a further embodiment of the invention, the device is provided with an element for automatically emptying the milk-collecting vessel after a dairy animal has been milked, so that the milk-collecting vessel is suitable for containing an amount of milk obtained during only one milking run of the dairy animal. This embodiment makes it possible to take, in a simple manner, a mixture sample of the milk obtained during the milking process. Because this mixture sample is a sample of the total amount of milk in the milk-collecting vessel, it is representative of the milk from the relevant dairy animal.

In a particular embodiment, the device comprises a controlling computer for emitting a destination signal, and the milk outlet is controllable by the destination signal and suitable for guiding milk selectively to several destinations. This embodiment also makes it possible to store the milk obtained during a milking process until the milking process has finished, after which it is possible for the controlling computer to decide afterwards to give the total amount of milk a particular destination.

In a particular embodiment, the milk-collecting vessel comprises a volume meter. Said meter provides the possibility of measuring the total amount of milk obtained as an integral whole.

In yet another embodiment, the milk-collecting vessel comprises a stirring device for moving milk. By keeping the milk in motion in an active manner, there is created a flow along the cooling surface, so that a good heat transfer is obtained.

### BRIEF DESCRIPTION OF DRAWINGS

An embodiment of the invention will now be explained in further detail by way of example only with reference to the accompanying figures, in which:

FIG. 1 is a side view of a device according to the invention, in which a cow is present;

FIG. 2 is a cross-sectional view of a milk-collecting vessel according to the invention, the cooling surface comprising a spreading surface; and

FIG. 3 is a cross-sectional view of a milk-collecting vessel according to the invention with a coil cooler.

### DETAILED DESCRIPTION

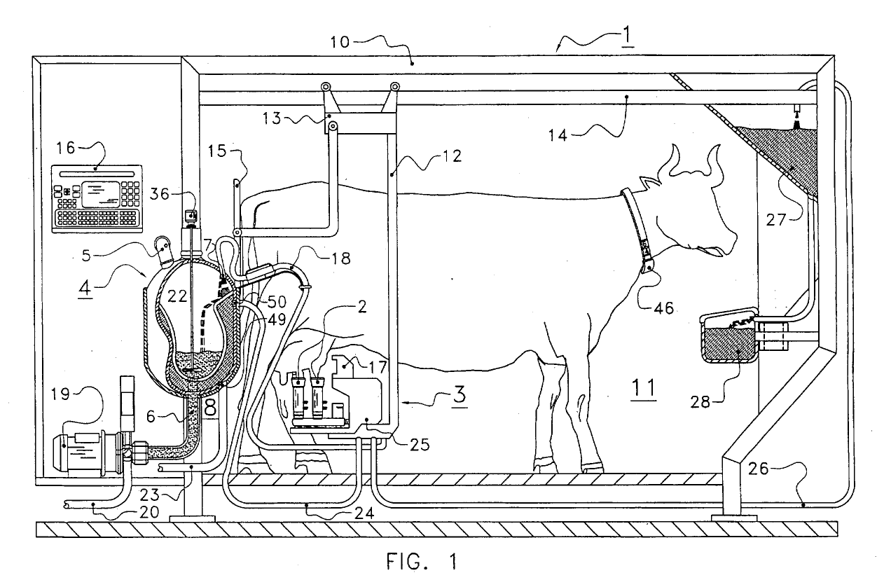

FIG. 1 shows a device 1 for automatically milking dairy animals. The device may be an automatic milking device of the type known from U.S. Pat. No. 6,213,051, the contents of which are hereby incorporated by reference in their entirety. The device 1 comprises teat cups 2 for drawing milk from a dairy animal and for generating a milk-air mixture, a robot arm 3 for automatically connecting the teat cups 2 to the teats of the dairy animal and a milk-collecting vessel 4 provided with a connection 5 connected to a vacuum source. The milk-collecting vessel 4 is provided with a milk outlet 6 for discharging the milk to milk-processing means, such as a milk-cooling tank, and with at least one milk inlet 7 for letting the milk-air mixture in. There is also at least one milk connection device 18 between a teat cup 2 and the milk inlet 7 for conveying the milk-air mixture. A vessel-cooling device 8 is provided for cooling the contents of the milk-collecting vessel 4. The vessel-cooling device 8 comprises a cooling surface 9 having a milk side 47 for contact with the milk and a cooling medium side 48 for contact with a cooling medium.

The device comprises a box-like frame 10 to which various components are attached. A dairy cow is depicted in the animal area 11 surrounded by the frame 10. There is disposed a robot arm 3 for automatically connecting teat cups 2 to the teats of the cow. The robot arm 3 is connected via a connecting element 12 to a guide element 13. The robot arm 3 is movable in the longitudinal direction of the device 1 over a rail 14. To the guide element 13 there is also connected a device 15 for following the rear of the animal, by means of which the controlling computer 16 of the device 1 can position the robot arm 3 relative to the rear side of the animal. For determining the position of the teats, the robot arm 3 comprises a laser 17. The connection of the teat cups 2 is carried out in a known manner by means of positioning means such as pneumatic cylinders and is controlled by the central controlling computer 16. The milk drawn by the teat cups 2 is passed to the milk inlet 7 via a milk connection device 18 in the form of a milk tube. There is disposed a vacuum connection 5 with a connection to a vacuum source (not shown), such as a frequency-controlled vacuum pump, for bringing the milk-collecting vessel 4 under vacuum. Said vacuum connection 5 ensures the removal of air that has come along with the milk from the teat cups 2.

In the lower part of the milk-collecting vessel 4 there is disposed a milk outlet 6 that is connected to a milk pump 19. Said milk pump 19 can convey the milk via a pressure line 20 to further processing means. Such a further processing device may be for example a milk-cooling tank for storing milk obtained during some days at a temperature of approximately 4 Å° C. Between the device 1 and the milk-cooling tank there may be arranged a cooled or non-cooled buffer tank for short-term storage of milk, if the milk-cooling tank is not able to receive milk, for example when it is cleaned or emptied.

It is advantageous to cool the milk before it gets into the further processing means. Cooling inhibits bacterial growth in the milk and in the milk residues remaining on walls that have been in contact with milk. This is of particular importance for automatic milking devices, because these devices are in operation during a considerable part of the day and comprise lines and accessories that are, consequently, in contact with milk for the major part of the day. The cooling need not necessarily be performed so as to achieve the required storage temperature of 4 Å° C. for having a bacteria-inhibiting effect. Furthermore, pre-cooling relieves the cooling system of the milk tank and renders a cooling installation for a buffer tank superfluous.

For the purpose of cooling the milk in the milk-collecting vessel 4, there is disposed a vessel-cooling device 8. For the sake of clarity the milk-collecting vessel 4 is shown partially cut-away. The vessel-cooling device 8 comprises a cooling medium space 21 surrounding the milk space 22. Cooling water is supplied to said space from the lower side via a cooling medium supply line 23. The warmed up cooling medium leaves the cooling medium space 21 at the upper side and is passed via a line 24 to a connection-device-cooling device 25. The latter device is located on the robot arm 3. In said device the cooling medium is passed in counterflow along the milk tubes guiding the milk coming from the teat cups 2 to the milk-collecting vessel 4.

A further line 26 guides the cooling medium to a cooling-medium-collecting reservoir 27 in the upper part of the device 1. Said cooling-medium-collecting reservoir 27 feeds the drinking trough 28. A float (not shown) ensures in a known manner a constant water level in the drinking trough 28. In the cooling-medium-collecting reservoir 27 there is provided an overflow and a float-controlled connection with a drinking-water line to ensure that the water level is maintained between a maximum and a minimum.

The cooling medium may also be discharged directly, for example in a dung pit. The latter option has the advantage that a cooling medium flow is possible at all times, irrespective of the drinking-water consumption from the cooling-medium-collecting reservoir 27. The advantage of the drinking trough 28 in the device 1 is that it functions as an extra enticement for the dairy animals. Furthermore, via the drinking trough 28 it is possible to use the warmed up cooling water in a simple, direct manner.

In one embodiment (not shown), the drinking trough 28 is provided with a controllable cover or can be swung aside as a whole, so that the animal can be prevented from drinking after the milking process. This prevents that the device 1 is unnecessarily occupied.

In another embodiment (not shown), the supply of cooling water can be controlled by the controlling computer 16 via a valve in the cooling medium supply line 23. In this manner flowing of cooling water is only necessary when milking takes place.

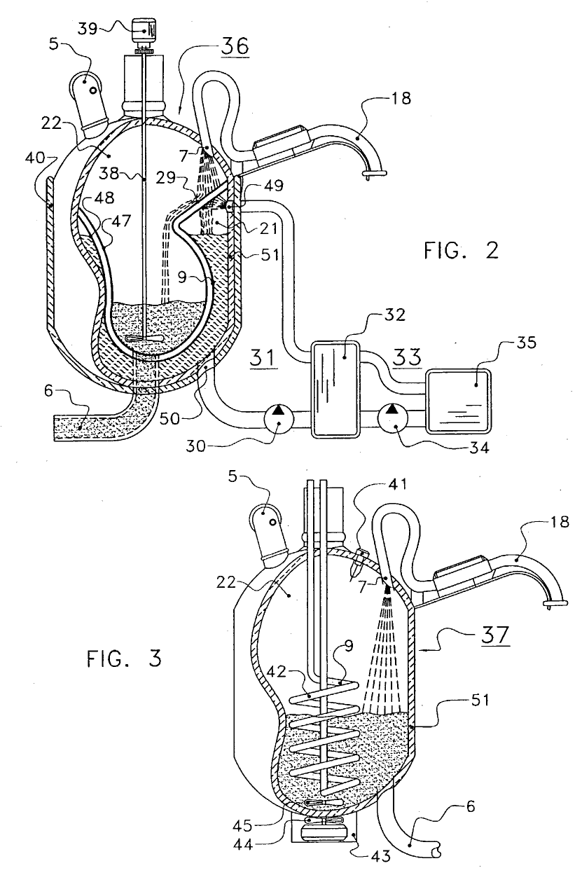

FIG. 2 shows a cut-away milk-collecting vessel 36 according to an alternative embodiment of the invention, the milk-collecting vessel 36 comprising a spreading surface 29 for spreading the milk to be supplied to the milk-collecting vessel 36. The milk inlet 7 is located above the spreading surface 29. The spreading surface 29 makes an angle of between 10 Å° and 80 Å° to the vertical. The milk-air mixture supplied by the milk tube 18 falls onto the spreading surface 29. The milk spreads over said surface and slides downwards along the spreading surface 29. The air is exhausted by the vacuum connection 5. Cold cooling medium is passed against the other side of the spreading surface 29. Due to the fact that the milk flows over the spreading surface 29 in a thin layer, there is a large heat transfer.

As cooling medium for example ice water or salt water may be used. A circulation pump 30 circulates said cooling medium through the cooling medium circuit 31 and causes it to pass along a heat exchanger 32. In the cooling medium circuit 31 there may also be included a connection-device-cooling device 25, as described in the foregoing. The use of ice water has the advantage over conventional coolants that freezing of milk to the cooling surface 9 is impossible. An additional advantage is that the heat exchanger 32 can be used as an extra cold buffer by means of the storage of ice.

The cooling medium itself is recycled by cooling it in a known manner by means of a second cooling circuit 33 in which a compressor 34 and a condenser 35 are included.

The heat exchanger 32 may also be located in the cooling medium space 21. In that case a second cooling medium circuit is superfluous.

If there are provided several devices, several milk-collecting vessels may be connected, both in series and in parallel, to the same cooling medium circuit 31. This simplifies the cooling device.

A stirring device 38, driven by a small electric motor 39, ensures a constant movement of the milk along the cooling surface 9. The cooling medium space 21 is surround by an insulation layer 40 for minimising loss of cold towards the outside air.

The vessel-cooling device 8 may also function according to the evaporation principle. In that case the cooling medium is brought, after the condenser 35, directly into the cooling medium space 21 where it evaporates and removes heat from the cooling surface 9.

FIG. 3 shows a cut-away milk-collecting vessel 37 according to the invention, the wall 51 of the milk-collecting vessel 37 at least partially surrounding the cooling surface 9. The cooling surface 9 comprises the surface of a coil cooler 42. In this embodiment the cooling medium is passed through the curved tube of the coil cooler 42. The cooling medium may both be recycled according to the cooling device as shown in FIG. 2 and be guided to a drinking trough 28 as shown in FIG. 1. There is disposed a magnetic stirring device 43 for keeping the milk to be cooled in movement and thus ensuring a better heat transfer. For this purpose a magnet 44 disposed on the axis of an electric motor drives a magnetic stirring bar 45. The motor is disposed outside the milk-collecting vessel 37. Due to the fact that the milk-collecting vessel 37 is non-metallic at its lower side, the stirring bar 45 is taken along by the rotating magnet 44.

As an alternative to a coil cooler 42 a plate cooler (not shown) may be used. Said plate cooler consists of a number of flat, hollow plates each surrounding a cooling medium space through which the cooling medium is passed. Because the cooling surface is plate-shaped and consequently has a relatively large surface, it has a large cooling capacity.

In the milk-collecting vessel 4, 36, 37 there may be provided a level meter (not shown) by means of which the amount of milk can be measured. If such a level meter is present, the milk-collecting vessel 4, 36, 37 need not have such a size that it is able to contain in all cases the amount of milk from an entire milking run. By switching the milk pump 19 on when a certain level has been attained and by switching it off when a certain lower level has been attained, the level is maintained between two values. The same effect can be obtained by causing the milk pump 19 to function at a variable speed. The rate of flow of the milk to be pumped away is thus adapted to the amount of milk supplied to the milk-collecting vessel 4, 36, 37 or to the amount of milk present in the milk-collecting vessel 4, 36, 37.

It may be advantageous if the dimensions of the milk-collecting vessel 4, 36, 37 are such that the total amount of milk from one milking run can temporarily be stored therein. Thus the controlling computer 16 has to decide only after a milking run has finished whether the total amount of milk should be given a different destination, for example if the milk does not come up to the consumption standard. This may then take place on the basis of measurement data obtained for all the phases of the milking.

In an alternative embodiment, the milk-collecting vessel may be provided as a common buffer vessel of the type known from co-pending U.S. patent application Ser. No. 10/249,955 by the present inventor entitled “A device for automatically milking an animal” and filed May 22, 2003, the contents of which are hereby incorporated by reference in their entirety.

In another embodiment (not shown), the device may comprise several storage vessels for milk with different destinations, such as colostrum or milk from sick dairy animals. For this purpose the milk outlet may be connected via valves to a storage vessel. The valves are controllable by the controlling computer. An embodiment in which a hose that is movable by the controlling computer guides the milk to the relevant storage vessel is also possible. Due to the fact that the milk to be separated has already been cooled in the milk-collecting vessel, the storage vessel does not require separate cooling. Furthermore, the storage vessel does not have to meet special requirements as regards size and shape. A simple bucket will suffice.

The pressure in the milk-collecting vessel 4, 36, 37 is in direct relation to the milking vacuum with which the milk is drawn from the animal. In order to maintain a constant pressure, there is disposed a vacuum regulator. In the embodiment shown said vacuum regulator comprises a pressure sensor 41. By means of the data obtained by the pressure sensor 41, a vacuum pump (not shown) is controlled. In a one embodiment (not shown) for controlling the vacuum, the pressure sensor 41 may control in a known manner an air inlet valve or a throttle valve in the vacuum line to the vacuum pump.

The functioning of the device will be described briefly hereinafter. A cow reports at the device 1 and said animal is identified by means of the responder 46 around its neck. If the computer 16 decides that the animal should be milked, the entrance door of the device is opened and the animal can enter the animal area 11. The robot arm 3 moves to a position below the udder of the animal, cleans the udder and connects the teat cups 2 one by one, after which the milking is started. If the animal drinks from the drinking trough 28 during milking, the water level in the drinking trough 28 will fall and a float will open a water inlet. The drinking trough 28 is filled from the cooling medium-collecting reservoir 27.

During milking a mixture of drawn off milk and air is created in the teat cups 2. In the arm, the temperature, conductivity and colour of the milk are measured by sensors. The data are passed to and processed by the controlling computer 16. By means of the milking vacuum the milk-air mixture flows via the connection-device-cooling device 25 to the milk-collecting vessel 4. Here the milk falls to the bottom of the vessel and the air is discharged via the vacuum connection 5 to the vacuum pump. In this embodiment the milk rests in the milk-collecting vessel 4 until the entire milking process has finished.

During the duration of the milking, the milk gives out heat to the water in the cooling medium space 21. By means of the pressure in the line 23, cool water is supplied to the cooling medium space 21. At the same time warmed up water is passed via the cooling medium outlet 50 and the connection-device-cooling device 25 to the cooling-medium-collecting reservoir 27. When the level in the cooling-medium-collecting reservoir has attained a certain maximum, the flow of the water will be stopped by a shut-off valve.

When the milk flow has come below a certain threshold, the milking process is finished. The teat cups 2 are disconnected, the teats are disinfected and the exit of the device is opened. On the basis of the measurement data the controlling computer 16 decides what destination should be given to the milk. A valve (not shown) in the vacuum connection is closed and the milk-collecting vessel 4 is aerated. Then the correct valves to the relevant further milk-processing units are opened and the milk pump 19 is started.

After the computer 16 has received an empty-report from the milk-collecting vessel 4, the cleaning device (not shown) is started. The cleaning device cleans the milk-collecting vessel 4 and the further components that have come into contact with milk, including the teat cups 2. If warm water is used for cleaning, before the cleaning process is started, first the cooling medium space 21 and the connection-device-cooling device 25 are made free from cooling water by emptying them by means of compressed air towards the cooling-medium-collecting reservoir 27. This procedure limits the cooling down of the cleaning agent.

Many modifications in addition to those described above may be made to the structures and techniques described herein without departing from the spirit and scope of the invention. Accordingly, although specific embodiments have been described, these are examples only and are not limiting upon the scope of the invention.

1. A device for automatically milking dairy animals, comprising:
a teat cup for drawing milk from a dairy animal and for generating a milk-air mixture;
a robot arm for automatically connecting the teat cup to a teat of the dairy animal;
a single milk-collecting vessel provided with a vacuum connection connectable to a vacuum source, with a milk outlet for discharging the milk to milk-processing means, and with at least one milk inlet for admitting the milk-air mixture;
at least one milk connection device between the teat cup and the milk inlet for conveying the milk-air mixture, and
a vessel-cooling device for cooling the contents of the milk-collecting vessel, the vessel-cooling device comprising a cooling surface having a milk side for contact with the milk and having a cooling medium side for contact with a cooling medium.

2. The device as claimed in claim 1, wherein the cooling medium side comprises part of a wall of a cooling medium space for containing the cooling medium.

3. The device as claimed in claim 2, further comprising a circulating device for moving the cooling medium in the cooling medium space.

4. The device as claimed in claim 2, wherein the cooling medium space comprises a cooling medium inlet and a cooling medium outlet for the cooling medium.

5. The device as claimed in claim 4, wherein the device comprises a drinking trough for watering an animal, and the cooling medium outlet is connected via a line to the drinking trough.

6. The device as claimed in claim 1, wherein the device comprises an ice water supply as cooling medium.

7. The device as claimed in claim 1, wherein the device comprises a vacuum regulator for regulating vacuum in the milk-collecting vessel.

8. The device as claimed in claim 1, wherein the wall of the milk-collecting vessel comprises the cooling surface.

9. The device as claimed in claim 1, wherein the milk inlet is disposed at an upper side of the milk-collecting vessel.

10. The device as claimed in claim 9, wherein the milk-collecting vessel comprises a spreading surface for spreading the milk to be supplied to the milk-collecting vessel.

11. The device as claimed in claim 10, wherein the milk inlet is located above the spreading surface.

12. The device as claimed in claim 11, wherein the spreading surface makes an angle of between 10 Å° and 80 Å° relative to vertical.

13. The device as claimed in claim 10, wherein the cooling surface comprises at least partially the spreading surface.

14. The device as claimed in claim 1, wherein a wall of the milk-collecting vessel surrounds at least partially the cooling surface.

15. The device as claimed in claim 1, wherein the vessel-cooling device comprises a coil cooler.

16. The device as claimed in claim 1, wherein the vessel-cooling device comprises a plate cooler.

17. The device as claimed in claim 1, wherein the device comprises a connection-device-cooling device for cooling milk to be passed through the milk connection device.

18. The device as claimed in claim 17, wherein the connection-device-cooling device is disposed on the robot arm.

19. The device as claimed in claim 18, further comprising a line for connecting the vessel-cooling device to the connection-device-cooling device.

20. The device as claimed in claim 19, wherein the cooling medium space comprises a cooling medium inlet and a cooling medium outlet for the cooling medium and the connection-device-cooling device is connected to the cooling medium outlet.

21. The device as claimed in claim 1, wherein the milk-collecting vessel is surrounded by a thermally insulating insulation layer.

22. The device as claimed in claim 1, wherein the milk-collecting vessel is sized to receive an amount of milk obtained during a single milking run of the dairy animal, and the device further comprises an automatic emptying device automatically emptying the milk-collecting vessel after the dairy animal has been milked.

23. The device as claimed in claim 1, wherein the device comprises a controlling computer for emitting a destination signal, and wherein the milk outlet is controllable by the destination signal to guide milk selectively to a plurality of destinations.

24. The device as claimed in claim 1, wherein the milk-collecting vessel comprises a volume meter.

25. The device as claimed in claim 1, wherein the milk-collecting vessel comprises a stirring device for moving milk.
